(19) United States
(12) Patent Application Publication
(10) Pub. No.: US 2018/0272461 A1
(43) Pub. Date: Sep. 27, 2018

(54) STEEL WORKPIECE WITH IMPROVED SURFACE QUALITY

(71) Applicants: THYSSENKRUPP STEEL EUROPE AG, Duisburg (DE); thyssenkrupp AG, Essen (DE)

(72) Inventors: Sascha SIKORA, Lünen (DE); Jens-Ulrik BECKER, Duisburg (DE); Stefan MYSLOWICKI, Mönchengladbach (DE); Melanie DINTER, Recklinghausen (DE); David PIERONEK, Dortmund (DE); Thorsten BEIER, Unna (DE)

(73) Assignees: THYSSENKRUPP STEEL EUROPE AG, Duisburg (DE); thyssenkrupp AG, Essen (DE)

(21) Appl. No.: 15/763,738

(22) PCT Filed: Sep. 30, 2015
(86) PCT No.: PCT/EP2015/072598

§ 371 Date: Mar. 27, 2018

(51) Int. Cl. B23K 20/04; C22C 1/02; B32B 15/01; C22C 38/00

(52) U.S. Cl. CPC B23K 20/04; C22C 1/02; B23K 2201/006; C22C 38/002; B32B 15/011

(57) ABSTRACT

A steel workpiece may have an edge region and a core region. The object of specifying a steel workpiece wherein a maximum near-surface strength and nevertheless favorable surface properties are achieved, especially favorable scaling characteristics during hot rolling, is achieved in that the steel workpiece may be softer in the edge region than in the core region, and in that a sum total of alloy constituents C, Si, Mn, Cr, and N of the steel workpiece overall is greater than 1.45% by weight. And in some examples the sum total of the alloy constituents C, Si, Mn, Cr, and N of the steel workpiece is less than 4.5% by weight.

The invention relates to a steel workpiece having an edge region and having a core region. The invention additionally relates to the use of a steel workpiece of the invention and to a chassis part, especially wheel, wheel carrier, wheel bearing, wheel suspension, carrier, axle, connecting rod or part thereof.

In the automobile industry, there is a constant search for new approaches and solutions for reduction of fuel consumption and/or for increasing the range. Lightweight construction has been identified as a key component for reduction of vehicle weight and hence for reduction of fuel consumption and for increasing the range. Material saving can be achieved by measures including the use of materials having enhanced strength.

Lightweight construction is particularly important specifically for chassis parts that are part of the unsprung mass. In operation, however, these components are subject to greatly varying cyclic stresses, which means that it is simultaneously desirable that the components have high fatigue resistance.

One possible approach to combining different properties in one component is the use of material composites. The prior art, for example DE 10 2008 022 709 A1, discloses the use, for example, of a multilayer material composite with three layers, produced by means of roll cladding. In order to meet the demands as required in the chassis region, especially on high operating strength, it is suggested that the outer layers be provided from a formable FB-W 600 steel alloy and the middle layer from an FeMn steel, where each of the outer layers should be 30% of the total thickness.

It is a problem, however, that, proceeding from a microalloyed steel that finds wide use in the chassis region, an increase in strength can lead to an adverse effect on the processing of the steel. For example, the scaling characteristics of the material may be altered to such a degree that a disadvantageous effect on the surface quality, for instance as a result of scale scars, of the hot strips can result from the hot rolling operation.

However, studies have shown that high strength and quality are of particular relevance specifically at the surface of the material. Especially in applications in which oscillating stresses occur under use conditions, defects in the material surface can lead to premature failure. For this reason, very high demands are made on the surface quality of the material used in such components.

Against this background, it is an object of the present invention to specify a steel workpiece, a use and a chassis component, wherein maximum near-surface strength and nevertheless favorable surface properties, especially favorable scaling characteristics during hot rolling, are achieved.

The object is achieved in a generic steel workpiece in that the steel workpiece is softer in the edge region than in the core region and in that the sum total of the alloy constituents C, Si, Mn, Cr and N in the steel workpiece overall is greater than 1.45% by weight.

The alloy constituents C, Si, Mn, Cr and N have a strength-enhancing effect on the steel alloy. However, it has been found that, when this group of alloy constituents is provided with a total value of more than 1.45% by weight, the necessary near-surface strength in the core region can be achieved, but nevertheless a sufficiently soft edge region can be provided in order to achieve improved surface quality of the steel workpiece. The sum total of the alloy constituents of the steel workpiece overall is understood to mean that the concentration in the entire steel workpiece including the core region and the edge region is considered on global or macroscopic average. Viewed locally or microscopically, it is thus possible, in particular, for a concentration of less than 1.45% by weight of these strength-enhancing alloy constituents to be provided in the edge region, and a concentration higher than 1.45% by weight in the core region. Viewed overall or globally, however, the concentration is higher than 1.45% by weight.

By virtue of the division of the steel material into a harder core region and a comparatively softer edge region in combination with a comparatively high minimum concentration of the alloy constituents C, Si, Mn, Cr and N, it is thus possible to avoid too low a fatigue resistance of the workpiece or of the component produced therefrom, while advantageous surface properties with regard to the scaling characteristics can, however, nevertheless still be assured during the hot rolling.

The edge region may especially be provided in such a way that the properties of a component produced from the steel workpiece are essentially determined by the core region. By contrast with the approaches from the prior art, it has been found that the edge region need not be provided in the manner of a functional layer which has to have a material effect on the properties of the later component. Instead, the edge region may be configured such that the properties thereof are advantageous in the manufacturing (for instance in the hot rolling), but are essentially of no significance any longer in the component produced from the steel workpiece. This can be achieved, for example, by the geometry, especially a low thickness, of the edge region, such that the properties of the later component are essentially determined by the core region.

The fact that the steel workpiece is softer in the edge region than in the core region means more particularly that the steel workpiece has a higher elongation at break, a lower tensile strength and/or a lower yield point in the edge region than in the core region.

The edge region may especially be regarded as the surface region of the steel workpiece. The edge region thus constitutes a soft layer applied to the steel workpiece.

The steel workpiece may especially be a semifinished product, a blank, a flat steel product, for example a steel sheet or a steel strip, or else a component.

It is conceivable in principle that the steel workpiece also has, on one or both sides, an organic or inorganic coating which is additionally applied to the soft edge region.

As particularly advantageous in one configuration of the steel workpiece according to the invention, the sum total of the alloy constituents C, Si, Mn, Cr and N of the steel workpiece overall is especially less than 4.5% by weight, preferably less than 4.0% by weight, especially preferably less than 3.5% by weight. It is true that an increase in the strength-enhancing alloy constituents can achieve an increase in strength which is advantageous for fatigue resistance. However, a limitation in the strength-enhancing alloy constituents of the steel workpiece to especially preferably less than 3.5% by weight prevents excessive strength in the edge region and hence a deterioration in the surface quality, for example as a result of scale scars, during manufacture.

It has been found to be particularly advantageous in relation to a high strength on the one hand and a simultaneously high surface quality when one or more of the following alloy constituents in % by weight of the steel workpiece overall are restricted as follows:

| | | |
|---|---|---|
| 0.05≤ | C | ≤0.5; |
| 0.060≤ | Si | ≤1.5; |
| 0.5≤ | Mn | ≤3.0; |
| | P | ≤0.03; |
| | S | ≤0.03; |
| | Al | ≤2.0; |
| | Cr | ≤1.5; |
| | Cu | ≤0.5; |
| | Mo | ≤0.5; |
| | N | ≤0.01; |
| | Ni | ≤0.5; |
| | Nb | ≤0.2; |
| | Ti | ≤0.5; |
| | V | ≤0.1; |
| | B | ≤0.1; |
| | As | ≤0.01; |
| | Sn | ≤0.05; |
| | Co | ≤0.02; |
| | Ca | ≤0.01. |

As already set out above, the steel workpiece may have higher or lower concentrations locally in different regions. What is crucial is that the respective condition is fulfilled in relation to the steel workpiece overall.

In a further preferred configuration of the steel workpiece according to the invention, the sum total of the alloy constituents C, Si, Mn, Cr and N in the edge region is especially greater than 0.01% by weight, preferably greater than 0.05% by weight, especially preferably greater than 0.1% by weight and/or less than 1.35% by weight. A minimum amount for the sum total of the strength-enhancing alloy constituents in the edge region prevents an excessive reduction in the strength of the steel workpiece overall, while a limitation in the maximum content of the strength-enhancing alloy constituents in total prevents an excessively high strength in the edge region, such that a sufficiently soft applied layer can be provided during the manufacture.

In a further preferred configuration of the steel workpiece of the invention, the sum total of the alloy constituents C, Si, Mn, Cr and N in the core region is greater than 1.7% by weight and/or especially less than 4.8% by weight, preferably less than 4.3% by weight, especially preferably less than 3.8% by weight. A minimum amount for the sum total of the strength-enhancing alloy constituents in the core region can achieve a sufficiently high strength of the steel workpiece overall, such that it is suitable for components under cyclic stress in particular. At the same time, a limitation in the sum total of the strength-enhancing alloy constituents in the core region can prevent positive properties of the soft edge region from being impaired by an excessively high near-surface strength.

In a further preferred configuration of the steel workpiece of the invention, the edge region of the steel workpiece is formed from two edge layers provided on either side of the core region. Provision of the softer edge region on either side can achieve a particularly high fatigue resistance of components produced from the steel workpiece, which is required especially in the case of chassis parts, since a high surface quality can be established in the manufacturing operation by virtue of the softness of the applied layer on either side.

It is conceivable in principle that the edge layers provided on either side are different. In a further configuration of the steel workpiece of the invention, however, it is advantageous when the edge layers provided on either side of the core region are essentially of the same construction in terms of their thickness and/or their composition. A symmetric construction of the steel workpiece leads firstly to more homogeneous properties of the steel workpiece and secondly to a simpler production process.

In a particularly preferred configuration of the steel workpiece of the invention, the edge layers provided on either side of the core region each have a thickness of less than 10%, preferably less than 5%, of the total thickness of the steel workpiece. It has been assumed to date that comparatively thick and soft surface layers had to be provided in order to sufficiently protect the surface properties, for instance in the hot rolling operation. However, it has been found that, even in the case of comparatively thin edge layers, in an operationally reliable manner, it is possible to achieve implementation of a high-quality strip surface through avoidance of scale scars. This additionally has the advantage that a high near-surface strength can simultaneously be achieved. Preferably, the thickness of each of the edge layers is between 3% and 5% or between 6% and 8% of the total thickness of the steel workpiece. In the case of thicknesses between 3% and 5%, especially about 4%, an especially near-surface strength can be achieved. In the case of thicknesses between 6% and 8%, especially about 7%, the edge region is correspondingly broader, such that higher degrees of rolling and/or higher temperatures can possibly be used in the manufacturing operation.

In a further preferred configuration of the steel workpiece of the invention, the tensile strength Rₘ of the steel workpiece overall is greater than 700 MPa, preferably greater than 800 MPa, further preferably greater than 900 MPa, especially preferably greater than 1000 MPa. It has been found that the steel workpieces described can achieve comparatively high tensile strengths without any problem, without any adverse effect on the scaling characteristics.

In order to obtain a particularly high tensile strength of the steel workpiece overall, the tensile strength Rₘ in the core region of the steel workpiece is greater than 700 MPa, preferably greater than 900 MPa, especially preferably greater than 1000 MPa. In this way, it is possible to execute the surface region correspondingly softly and nevertheless to achieve a high tensile strength.

Preferably, the tensile strength Rₘ in the edge region of the steel workpiece is less than 500 MPa, preferably less than 400 MPa. In the case of a correspondingly low tensile strengths, scale scars on the steel workpiece in the hot rolling operation can be avoided particularly effectively, such that a high surface quality is achieved.

In a further preferred configuration of the steel workpiece of the invention, the yield point R_{p0.2} of the steel workpiece overall is greater than 650 MPa, preferably greater than 700 MPa, especially preferably greater than 800 MPa. A steel workpiece having a comparatively high yield point can further improve the fatigue resistance of a component produced therefrom.

In order to obtain a high yield point of the steel workpiece overall, it is especially preferable when the yield point R_{p0.2} in the core region of the steel workpiece is greater than 700 MPa, preferably greater than 800 MPa, especially preferably greater than 1000 MPa.

By contrast, it is preferable when the yield point R_{p0.2} in the edge region of the steel workpiece is less than 400 MPa, preferably less than 300 MPa, in order to achieve very positive scaling characteristics during manufacture.

If the elongation at break A₈₀, in a further configuration of the steel workpiece of the invention, in the edge region is at least 15%, preferably at least 30%, a particularly soft applied layer can be provided, which enables particularly advantageous scaling characteristics of the steel workpiece.

By contrast, the elongation at break A₈₀ of the core region and/or of the steel workpiece overall, however, is preferably much lower, since this is determined by the harder core region. For example, the elongation at break A₈₀ of the core region and/or of the steel workpiece overall is between 3.0% and 10%.

In a further configuration of the steel workpiece of the invention, the steel workpiece is a composite structure and the core region and the edge region are formed by composite layers of the composite structure, the composite structure especially being produced by roll cladding. By virtue of a composite structure, the core region and the edge region can be implemented in a particularly simple manner in a steel workpiece. The alloy constituents of the individual layers can be adjusted precisely. The individual layers of the composite structure can be bonded to one another by cohesive joining, especially thermal joining. The composite structure is produced especially by cladding, preferably by roll cladding, especially preferably hot roll cladding. It is also conceivable, as an alternative, to produce the individual layers in a casting process.

In a further configuration of the steel workpiece of the invention, the core region is formed by a higher-strength or ultrahigh-strength steel material, especially by a complex phase steel, a dual phase steel, a martensite phase steel, a manganese-boron steel or a multiphase steel. These steel materials may have high strengths and impart a high fatigue resistance to the component produced from the steel material. A multiphase steel may especially be a TPN steel (triphasic steel with nanoprecipitates).

It has been found to be particularly advantageous in relation to a high strength when one or more of the following alloy constituents in % by weight in the core region are restricted as follows:

| | | |
|---|---|---|
| 0.060≤ | C | ≤0.45; |
| 0.050≤ | Si | ≤1.50; |
| 1.0≤ | Mn | ≤3.0; |
| | P | ≤0.020; |
| | S | ≤0.003; |
| | Al | ≤1.350; |
| | Cr | ≤0.9; |
| | Cu | ≤0.20; |
| | Mo | ≤0.3; |
| | N | ≤0.01; |
| | Ni | ≤0.100; |
| | Nb | ≤0.2; |
| | Ti | ≤0.2; |
| | V | ≤0.050; |
| | B | ≤0.01; |
| | As | ≤0.030; |
| | Sn | ≤0.030; |
| | Co | ≤0.010; |
| | Ca | ≤0.005. |

In a further configuration of the steel workpiece of the invention, the edge region is formed by a deep-drawing steel or a microalloyed steel of relatively high strength. These steel materials may be provided in sufficiently soft form, by means of which the formation of scale scars can be effectively minimized or suppressed.

It has been found to be particularly advantageous in relation to avoidance of scale scars in manufacture when one or more of the following alloy constituents in % by weight in the edge region are restricted as follows:

| | |
|---|---|
| C | ≤0.1; |
| Si | ≤0.5; |
| Mn | ≤1.0; |
| P | ≤0.03; |
| S | ≤0.02; |
| Al | ≤0.1; |
| Cr | ≤0.3; |
| Cu | ≤0.3; |
| Mo | ≤0.1; |
| N | ≤0.01; |
| Ni | ≤0.200; |
| Nb | ≤0.2; |
| Ti | ≤0.2; |
| B | ≤0.001; |
| Sn | ≤0.040. |

In a further configuration of the steel workpiece of the invention, the core region and the edge region are regions of a monolithic workpiece, the edge region especially being formed by an annealing operation. As an alternative to the formation of the core region and the edge region by joining of separate workpieces or casting, the steel workpiece can thus also be produced as a monolithic steel workpiece and the properties of the core region and/or the edge region can be adjusted (for instance via a subsequent annealing operation). An annealing operation of this kind may, for example, be edge decarburization and/or diffusion annealing. A steel workpiece of this kind can especially reduce the risk of delamination of individual layers.

The object stated at the outset is also achieved, in a second teaching of the invention, through use of a steel workpiece of the invention for production of a chassis part, especially a wheel, a wheel carrier, a wheel bearing, a wheel suspension, a carrier, an axle (of any kind), a connecting rod or a part thereof.

The object stated at the outset is additionally achieved, in a third teaching, by a chassis part, especially wheel, wheel carrier, wheel bearing, wheel suspension, carrier, axle (of any kind), connecting rod or part thereof, produced from a steel workpiece of the invention.

Chassis parts, especially the chassis parts of the unsprung mass, are subject to particularly high cyclic stress in use. By virtue of the steel materials of the invention, it is possible to provide chassis parts having a particularly high fatigue resistance and surface quality, such that the chassis parts are able to cope particularly well with the cyclic stresses that fluctuate significantly in operation.

In relation to further advantageous configurations, reference is made to the advantages and remarks relating to the configurations of the steel workpiece of the invention.

The invention is to be elucidated in detail hereinafter with reference to working examples in conjunction with the drawing. The drawing shows, in

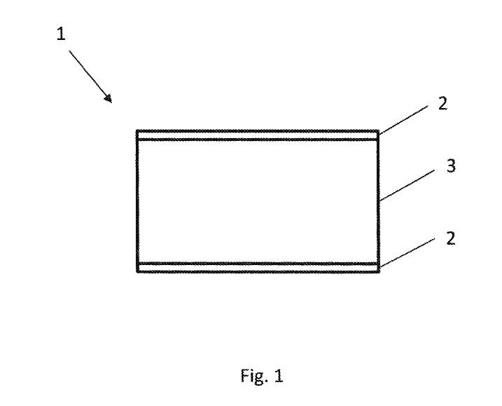

FIG. 1, a working example of a steel workpiece of the invention in the form of a composite structure.

FIG. 1 shows, by way of example, a working example of a steel workpiece of the invention in the form of a composite structure 1. The composite structure 1 has an edge region formed from two outer edge layers 2, and a core region in the form of a core layer 3. The edge layers 2 each have a thickness of less than 10% of the total thickness of the composite structure 1.

In connection with tables 1 to 5 at the end of the description, steel alloy compositions with alloy constituents in % by weight and the mechanical properties thereof are reported hereinafter by way of example for the core layer 3 and the edge layers 2, and for the overall composite structure 1.

Table 1a shows three alloy compositions A1, A2, A3, A4, which can be used for the edge layers 2. Alloys A1 and A2 are each deep-drawing steels, while alloys A3 and A4 are higher-strength steels. The table states the respective minimum and maximum strength-enhancing alloy constituents for each of the alloys A1 to A4. Optionally, alloys A1 to A4 contain one or more of the alloy constituents in % by weight that are restricted as follows:

| | |
|---|---|
| P | ≤0.03; |
| S | ≤0.03; |
| Al | ≤0.2; |
| Cr | ≤0.3; |
| Cu | ≤0.3; |
| Mo | ≤0.1; |
| N | ≤0.01; |
| Ni | ≤0.5; |
| Nb | ≤0.1; |
| Ti | ≤0.2; |
| B | ≤0.01; |
| Sn | ≤0.02; |
| Ca | ≤0.01. |

Table 1b shows the sum total of the alloy constituents C, Si, Mn, Cr and N for each of alloys A1 to A4. The sum total of the alloy constituents C, Si, Mn, Cr and N for each of alloys A1 to A4 is below 1.45% by weight. Alloys A1 to A4 have comparatively low tensile strengths and yield points, but comparatively high (minimum) elongations at break.

Table 2a then shows seven alloy compositions K1, K2, K3, K4, K5, K6, K7, which can be used for the core layer 3. Alloy K1 is a triphasic steel with nanoprecipitates, alloys K2 to K4 are complex-phase steels or dual-phase steels, alloy K5 is a martensite phase steel, alloy K6 is a manganese-boron steel and alloy K7 is a multiphase steel. The table again states the respective minimum and maximum strength-enhancing alloy constituents for each of alloys K1 to K7. Optionally, alloys K1 to K7 contain one or more of the alloy constituents in % by weight that are restricted as follows:

| | |
|---|---|
| P | ≤0.03; |
| S | ≤0.01; |
| Al | ≤1.5; |
| Cr | ≤1.0; |
| Cu | ≤0.2; |
| Mo | ≤0.3; |
| N | ≤0.01; |
| Ni | ≤0.3; |
| Nb | ≤0.1; |
| Ti | ≤0.2; |
| V | ≤0.1; |
| B | ≤0.01; |
| As | ≤0.02; |
| Sn | ≤0.05; |
| Co | ≤0.03; |
| Ca | ≤0.01. |

Table 2b shows the sum total of the alloy constituents C, Si, Mn, Cr and N for each of alloys K1 to K7. The sum total of the alloy constituents C, Si, Mn, Cr and N for each of alloys K1 to K7 is above 1.45% by weight. Alloys K1 to K7 have comparatively high tensile strengths and yield points, but comparatively low (minimum) elongations at break.

Tables 3 to 5 now show different working examples, identified as V1 to V15, of different composite structures 1. What is stated here in the “Construction” column is which of the alloys K1 to K7 has been used for the core layer 3 and which of the alloys A1 to A4 for the edge layers 2. Additionally stated is the percentage of a layer in the total thickness of the composite structure 1. In the examples V1 to V15 reported, the percentage thickness of the edge layers 2 in each case is either 4% (V1, V3) or 7% (V2, V4 to V15) of the total thickness of the composite structure 1. Thus, a symmetric layer structure has been chosen in each case. In this case, the composite structure 1 has been produced, for example, by hot roll cladding of the individual layers 2, 3.

In addition, the sum total of the alloy constituents C, Si, Mn, Cr and N is reported for the composite structure 1 overall. Finally, where available, the mechanical values of the respective composite structure 1 of working examples V1 to V15 are reported, especially the tensile strength, the yield point and the (minimum) elongation at break.

As can be seen, the sum total of the alloy constituents C, Si, Mn, Cr and N of the composite structure 1 overall is greater than 1.45% by weight in each case. It has been found that, observing this condition, the composite structure 1 according to examples V1 to V15 overall can achieve high values in each case for the tensile strength and yield point, whereas the edge layers 2, each of which are formed by one of the alloys A1 to A4, provide a soft applied layer. This enables manufacture with avoidance of scale scars, but a high near-surface strength is simultaneously achieved. The result is that it is thus possible to provide a composite structure 1 with which components having a high fatigue resistance, especially under highly fluctuating cyclic stresses, can be provided.

The above remarks in relation to a steel workpiece in the form of a composite structure 1 are likewise applicable to steel workpieces that are in monolithic form, for example. In this case, the alloy compositions that vary over the thickness of the steel workpiece can be adjusted, for example, via subsequent heat treatment.

TABLE 1a

| | | C | Si | Mn | Cr | N |
|---|---|---|---|---|---|---|
| A1 | min. | 0.020 | | 0.16 | | 0.003 |
| | max. | 0.055 | 0.04 | 0.30 | 0.06 | 0.006 |
| A2 | min. | | | 0.11 | | |
| | max. | 0.003 | 0.02 | 0.17 | 0.05 | 0.004 |
| A3 | min. | 0.060 | 0.17 | 0.75 | | |
| | max. | 0.080 | 0.24 | 0.85 | 0.15 | 0.006 |
| A4 | min. | 0.027 | 0.057 | 0.34 | | 0.001 |
| | max. | 0.046 | 0.10 | 0.44 | 0.09 | 0.005 |

TABLE 1b

| | | C + Si + Mn + Cr + N | Rₘ | R_{p0.2} | A₈₀ |
|---|---|---|---|---|---|
| A1 | min. | 0.18 | 370 MPa | 280 MPa | >30.0% |
| | max. | 0.46 | | | |
| A2 | min. | 0.11 | 370 MPa | 280 MPa | >33.0% |
| | max. | 0.25 | | | |
| A3 | min. | 0.98 | 410 MPa | 340 MPa | >15.0% |
| | max. | 1.33 | | | |
| A4 | min. | 0.43 | 383 MPa | 300 MPa | >26.0% |
| | max. | 0.68 | | | |

TABLE 2a

| | | C | Si | Mn | Cr | N |
|---|---|---|---|---|---|---|
| K1 | min. | 0.155 | 0.25 | 1.45 | | |
| | max. | 0.170 | 0.30 | 1.60 | 0.10 | 0.005 |
| K2 | min. | 0.060 | 0.57 | 1.77 | 0.32 | |
| | max. | 0.070 | 0.67 | 1.92 | 0.42 | 0.006 |
| K3 | min. | 0.065 | 0.25 | 2.50 | 0.65 | |
| | max. | 0.080 | 0.30 | 2.65 | 0.75 | 0.006 |
| K4 | min. | 0.140 | 0.65 | 1.85 | 0.30 | |
| | max. | 0.160 | 0.75 | 2.00 | 0.40 | 0.005 |
| K5 | min. | 0.110 | 0.05 | 1.40 | 0.20 | |
| | max. | 0.125 | 0.10 | 1.50 | 0.30 | 0.005 |
| K6 | min. | 0.220 | 0.20 | 1.20 | 0.10 | |
| | max. | 0.250 | 0.30 | 1.35 | 0.20 | 0.007 |
| K7 | min. | 0.125 | 0.33 | 1.70 | 0.26 | |
| | max. | 0.143 | 0.40 | 1.84 | 0.36 | 0.006 |

TABLE 2b

| | | C + Si + Mn + Cr + N | Rₘ | | R_{p0.2} | | A₈₀ |
|---|---|---|---|---|---|---|---|
| K1 | min. | 1.86 | 780 | MPa | | | |
| | max. | 2.18 | | | | | |
| K2 | min. | 2.72 | 800 | MPa | | | |
| | max. | 3.09 | | | | | |
| K3 | min. | 3.47 | 1000 | MPa | 750 | MPa | >10.0% |
| | max. | 3.79 | | | | | |
| K4 | min. | 2.94 | 1000 | MPa | 810 | MPa | >8.0% |
| | max. | 3.32 | | | | | |
| K5 | min. | 1.76 | 1200 | MPa | 1050 | MPa | >3.5% |
| | max. | 2.03 | | | | | |
| K6 | min. | 1.72 | 1500 | MPa | 1000 | MPa | >5.5% |
| | max. | 2.11 | | | | | |
| K7 | min. | 2.41 | 1047 | MPa | 903 | MPa | >6.8% |
| | max. | 2.75 | | | | | |

TABLE 3

| | | | | C + Si + | | | |
|---|---|---|---|---|---|---|---|
| | Construction | | | Mn + Cr + N | Rₘ | R_{p0.2} | A₈₀ |
| V1 | A3 | 4% | min. | 1.70 | 1137 MPa | 993 MPa | 3.5% |
| | K5 | 92% | max. | 1.97 | | | |
| | A3 | 4% | | | | | |
| V2 | A3 | 7% | min. | 1.65 | 1089 MPa | 951 MPa | 3.5% |
| | K5 | 86% | max. | 1.93 | | | |
| | A3 | 7% | | | | | |
| V3 | A3 | 4% | min. | 2.78 | 953 MPa | 772 MPa | 8.0% |
| | K4 | 92% | max. | 3.16 | | | |
| | A3 | 4% | | | | | |
| V4 | A3 | 7% | min. | 2.67 | 917 MPa | 744 MPa | 8.0% |
| | K4 | 86% | max. | 3.16 | | | |
| | A3 | 7% | | | | | |

TABLE 4

| | | | | C + | | | |
|---|---|---|---|---|---|---|---|
| | | | | Si + Mn + | | | |
| | Construction | | | Cr + N | Rₘ | R_{p0.2} | A₈₀ |
| V5 | A1 | 7% | min. | 3.01 | 912 MPa | 684 MPa | 10.0% |
| | K3 | 86% | max. | 3.32 | | | |
| | A1 | 7% | | | | | |
| V6 | A2 | 7% | min. | 3.00 | 912 MPa | 684 MPa | 10.0% |
| | K3 | 86% | max. | 3.29 | | | |
| | A2 | 7% | | | | | |
| V7 | A3 | 7% | min. | 3.12 | 917 MPa | 693 MPa | 10.0% |
| | K3 | 86% | max. | 3.44 | | | |
| | A3 | 7% | | | | | |
| V8 | A1 | 7% | min. | 1.50 | 1342 MPa | 899 MPa | 5.5% |
| | K6 | 86% | max. | 1.88 | | | |
| | A1 | 7% | | | | | |
| V9 | A2 | 7% | min. | 1.49 | 1342 MPa | 899 MPa | 5.5% |
| | K6 | 86% | max. | 1.85 | | | |
| | A2 | 7% | | | | | |
| V10 | A3 | 7% | min. | 1.62 | 1347 MPa | 908 MPa | 5.5% |
| | K6 | 86% | max. | 2.00 | | | |
| | A3 | 7% | | | | | |

TABLE 5

| | Construction | | | C + Si + Mn + Cr + N | Rₘ | |
|---|---|---|---|---|---|---|
| V11 | A4 | 7% | min. | 3.04 | 914 | MPa |
| | K2 | 86% | max. | 3.35 | | |
| | A4 | 7% | | | | |
| V12 | A4 | 7% | min. | 2.59 | 914 | MPa |
| | K4 | 86% | max. | 2.95 | | |
| | A4 | 7% | | | | |
| V13 | A4 | 7% | min. | 1.57 | 1086 | MPa |
| | K5 | 86% | max. | 1.84 | | |
| | A4 | 7% | | | | |
| V14 | A4 | 7% | min. | 1.54 | 1344 | MPa |
| | K6 | 86% | max. | 1.91 | | |
| | A4 | 7% | | | | |
| V15 | A4 | 7% | min. | 2.13 | 954 | MPa |
| | K7 | 86% | max. | 2.46 | | |
| | A4 | 7% | | | | |

1.-16. (canceled)

17. A steel workpiece comprising:
an edge region; and
a core region, wherein the edge region is softer than the core region,
wherein a sum total of alloy constituents C, Si, Mn, Cr, and N of the steel workpiece is greater than 1.45% by weight.

18. The steel workpiece of claim 17 wherein the sum total of the alloy constituents C, Si, Mn, Cr, and N of the steel workpiece is less than 4.5% by weight.

19. The steel workpiece of claim 17 wherein a sum total of the alloy constituents C, Si, Mn, Cr, and N in the edge region is greater than 0.01% by weight.

20. The steel workpiece of claim 17 wherein a sum total of the alloy constituents C, Si, Mn, Cr, and N in the edge region is less than 1.35% by weight.

21. The steel workpiece of claim 17 wherein a sum total of the alloy constituents C, Si, Mn, Cr, and N in the core region is greater than 1.7% by weight.

22. The steel workpiece of claim 17 wherein a sum total of the alloy constituents C, Si, Mn, Cr, and N in the core region is less than 4.8% by weight.

23. The steel workpiece of claim 17 wherein a sum total of the alloy constituents C, Si, Mn, Cr, and N in the core region is in a range of 1.7% to 4.8% by weight.

24. The steel workpiece of claim 17 wherein the edge region comprises two edge layers disposed on opposite sides of the core region.

25. The steel workpiece of claim 24 wherein at least one of a thickness or a composition of the two edge layers is the same.

26. The steel workpiece of claim 24 wherein the two edge layers have a thickness of less than 10% of a total thickness of the steel workpiece.

27. The steel workpiece of claim 17 having a tensile strength Rₘ that is greater than 700 MPa.

28. The steel workpiece of claim 17 having a yield point R_{p0.2} that is greater than 650 MPa.

29. The steel workpiece of claim 17 wherein the edge region has an elongation at break A₈₀ of at least 15%.

30. The steel workpiece of claim 17 having a composite structure, wherein the core region and the edge region are formed by composite layers of the composite structure.

31. The steel workpiece of claim 17 having a roll-cladded composite structure, wherein the core region and the edge region are formed by composite layers of the roll-cladded composite structure.

32. The steel workpiece of claim 17 wherein the core region is comprised of a complex phase steel, a dual phase steel, a martensite phase steel, a manganese-boron steel, or a multiphase steel.

33. The steel workpiece of claim 17 wherein the edge region is comprised of a deep-drawn steel.

34. The steel workpiece of claim 17 wherein the edge region is comprised of a microalloyed steel.

35. The steel workpiece of claim 17 wherein the core region and the edge region are regions of a monolithic workpiece, with the edge region being annealed.

36. A chassis part including a steel workpiece that comprises:
an edge region; and
a core region, wherein the edge region is softer than the core region,
wherein a sum total of alloy constituents C, Si, Mn, Cr, and N of the steel workpiece is greater than 1.45% by weight,
wherein the chassis part is configured as a wheel, a wheel carrier, a wheel bearing, a wheel suspension, a carrier, an axle, a connecting rod, or a part thereof.
